(19) United States
(12) Patent Application Publication
(10) Pub. No.: US 2010/0235495 A1
(43) Pub. Date: Sep. 16, 2010

(54) METHODS AND SYSTEMS FOR REDUCING A LOAD ON A MULTI-TENANT DATABASE

(75) Inventors: David Petersen, Kensington, CA (US); Daniel Soble, Pleasanton, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: salesforce.com, Inc., San Francisco, CA (US)

(21) Appl. No.: 12/557,256

(22) Filed: Sep. 10, 2009

Related U.S. Application Data
(60) Provisional application No. 61/095,865, filed on Sep. 10, 2008.

(51) Int. Cl. G06F 15/173

(52) U.S. Cl. 709/224

(57) ABSTRACT

Mechanisms and methods for reducing a load on a multi-tenant database are provided. These mechanisms and methods for reducing a load on a multi-tenant database can enable a reduction in the computational effort expended to handle login requests with invalid usernames and the computational effort expended to handle valid login requests that occur at a high rate. The ability to provide a reduction in computational effort expended on login requests can enable a providing of a reliable level of resources to users and tenants of the multi-tenant database.

### CROSS-REFERENCE TO RELATED APPLICATIONS

This application claims priority from co-pending U.S. Provisional Patent Application No. 61/095,865, filed Sep. 10, 2008, entitled “METHODS AND SYSTEMS FOR IMPROVED RATE LIMITING IN A MULTI-TENANT ON-DEMAND ENVIRONMENT,” which is hereby incorporated by reference, as if set forth in full in this document, for all purposes.

The present application is related to the following commonly assigned U.S. patent application Ser. No. 11/616,657 (Attorney Docket No. 021735-002410US) entitled “METHOD AND SYSTEM FOR GOVERNING RESOURCE CONSUMPTION IN A MULTI-TENANT SYSTEM,” by Fry et al., filed Dec. 27, 2006, which is incorporated herein by reference for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to database systems, and more particularly to a methods and systems for reducing a load on a multi-tenant database.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional database systems, users access their data resources in one logical database. A user of such a conventional system typically retrieves data from and stores data on the system using the user's own systems. A user system might login and remotely access one of a plurality of server systems that might in turn access the database system. Data retrieval from the system might include a login request, acceptance of username/password, and the issuance of a query (i.e. a search request) from the user system to the database system. The database system might process the request for information received in the query and send to the user system information relevant to the request. The reliable and efficient retrieval of accurate information and subsequent delivery of this information to the user system has been and continues to be a goal of administrators of database systems.

Unfortunately, conventional database approaches are at the mercy of authorized users or even non-authorized users who might be requesting access to the database. For example, conventional databases might become overloaded with requests from both types of users.

Accordingly, it is desirable to provide systems and methods that prevent misuse or overloading of databases.

### BRIEF SUMMARY

In accordance with embodiments, there are provided mechanisms and methods for reducing a load on a multi-tenant database. These mechanisms and methods for reducing a load on a multi-tenant database can enable a reduction in the computational effort expended to handle login requests with invalid usernames and the computational effort expended to handle valid login requests that occur at a high rate. The ability of embodiments to provide a reduction in computational effort expended on login requests can enable embodiments to provide a reliable level of resources to users and tenants of the multi-tenant database.

In an embodiment and by way of example, a method for reducing a load on a multi-tenant database is provided. One or more servers of the multi-tenant database system receive a plurality of requests to login from one or more users of a first tenant. The multi-tenant database system determines a number of login requests received from the one or more users of the first tenant. The number of login requests is compared to a threshold number. It is then determined whether the number of login requests is greater than the threshold number.

Other embodiments of the invention are directed to systems and machine-readable media associated with methods described herein.

While the present invention is described with reference to an embodiment in which techniques for reducing a load on a multi-tenant database are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates a block diagram of an environment wherein an on-demand database service might be used.

FIGS. 2A and 2B illustrate a block diagram of an embodiment of elements of FIG. 1 and various possible interconnections between these elements according to an embodiment of the present invention.

FIG. 3 is a flow chart illustrating a method for reducing a load on a database from user logins according to embodiments of the present invention.

FIG. 4 shows a block diagram of a multi-tenant database having a plurality of servers and configured to limit a rate of user logins according to embodiments of the present invention.

FIG. 5 is a flow chart illustrating a method for reducing a user login load on a multi-tenant database having a plurality of servers according to embodiments of the present invention.

FIG. 6 is a flowchart illustrating a method for reducing a load on a database from invalid user logins according to embodiments of the present invention.

### DETAILED DESCRIPTION

### General Overview

Systems and methods are provided for reducing a load on a multi-tenant database by managing the login procedure to reduce the load spent on logins. These techniques for reducing a load on a multi-tenant database can enable embodiments to provide a more reliable operation, e.g., by preventing an improper number of login attempts of users and/or non-users from shutting down or severely affecting the operation of the database.

As used herein, the term multi-tenant database system refers to those systems in which various elements of hardware and software of the database system may be shared by one or more customers. For example, a given application server (e.g. running an application process) may simultaneously process requests for a great number of customers, and a given database table may store rows for a potentially much greater number of customers.

Next, mechanisms and methods for reducing a load on a multi-tenant database will be described with reference to example embodiments.

### System Overview

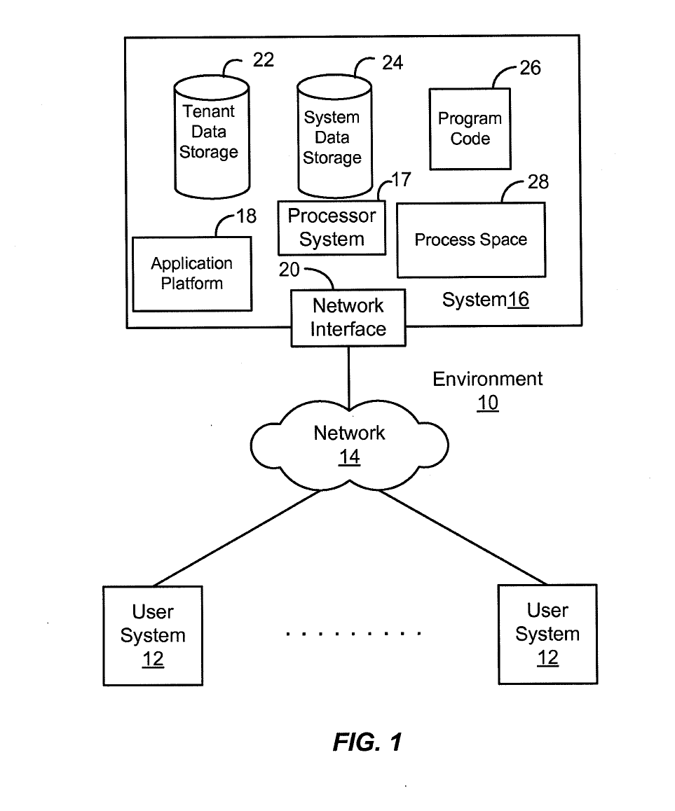

FIG. 1 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

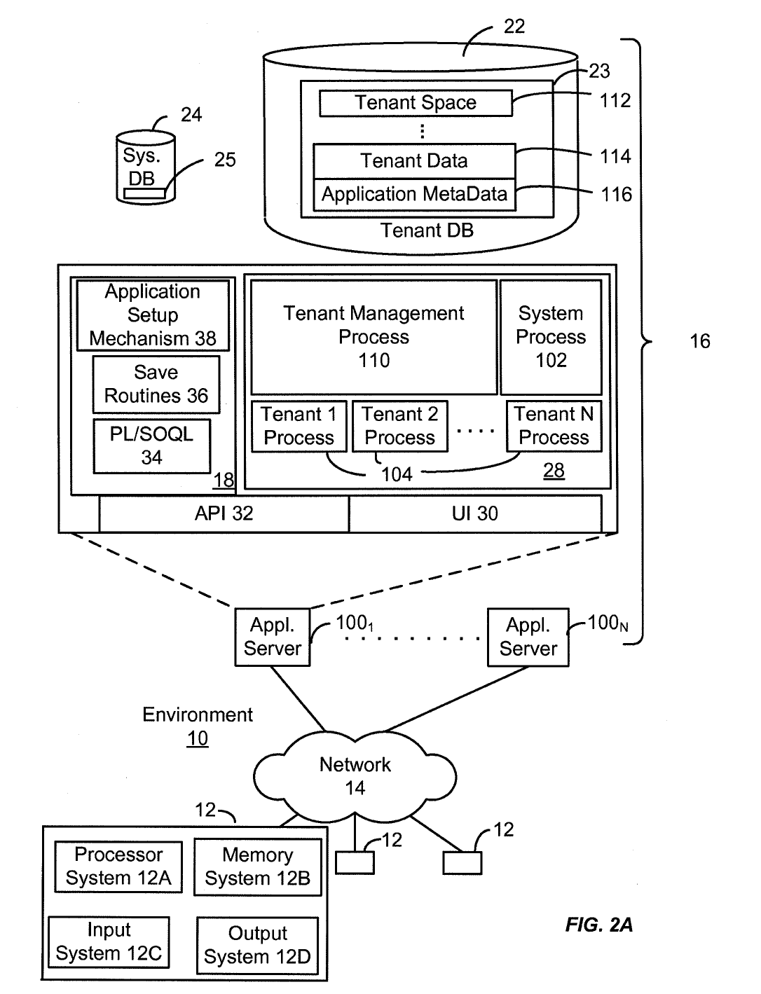

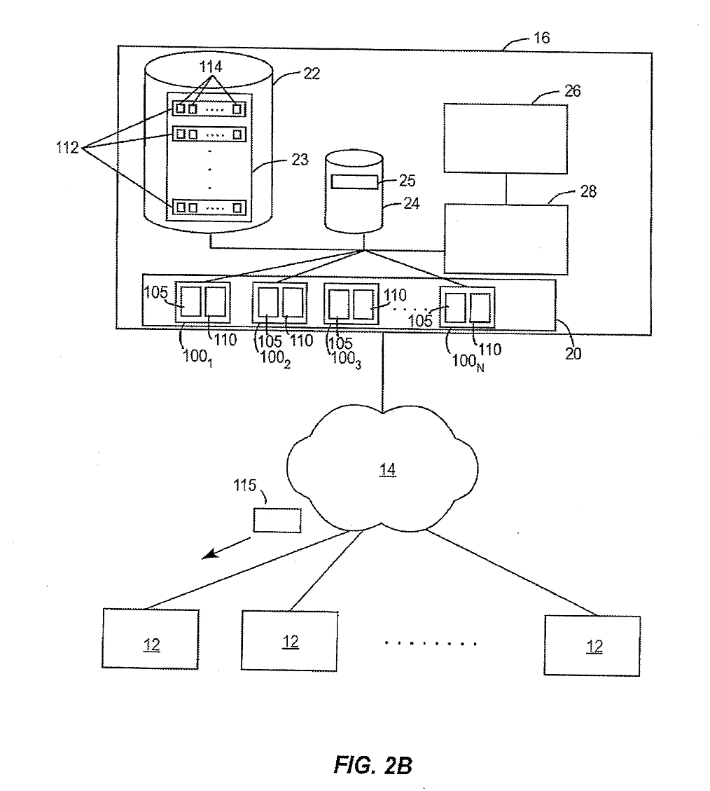

Environment 10 is an environment in which an on-demand database service exists. User system 12 may be any machine or system that is used by a user to access a database user system. For example, any of user systems 12 can be a handheld computing device, a mobile phone, a laptop computer, a work station, and/or a network of computing devices. As illustrated in FIG. 1 (and in more detail in FIG. 2) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications (application processes) as well as provide related data, code, forms, web pages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 1, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2A also illustrates environment 10. However, in FIG. 2A elements of system 16 and various interconnections in an embodiment are further illustrated. FIG. 2A shows that user system 12 may include processor system 12A, memory system 12B, input system 12C, and output system 12D. FIG. 2A shows network 14 and system 16. FIG. 2A also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2A, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more Oracle™ databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

A table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system.

The following detailed description first describes embodiments that track and can limit a number of logins from users, groups or users, and tenants of a database. Embodiments that use a plurality of application servers for providing the tracking and managing of login requests is then detailed. Following this, embodiments that limit an amount of computational effort expended for invalid users are described.

### Rate Limiting of User Logins

Login is one of the areas that a user can generate a load on a database. The load can arise from valid users logging into the database and from random garbage showing up on the login page(s), e.g., by a valid user mistyping the username or from an invalid user attempting to gain access or damage operation of the database. The former problem is addressed first.

In many database systems, a user may need to manually login each time the user attempts to access the database system. In such conventional systems, a user can manually type a username/password only so fast, and the user would typically not repeatedly login if the user were a bona fide user of the database. Thus, the amount of computational effort (load) expended by the database on such manual logins is typically not large.

However, embodiments of the present invention can provide an on-demand database service, which can provide an application interface similar to or the same as that of applications running locally. Also, the on-demand database service can provide tools that allow users to create customized applications for accessing the database. A clueless user writing bad code could inadvertently log into the database repeatedly via an application programming interface (API), e.g., inside of a record processing loop.

Additionally, embodiments can provide a multi-tenant database, which may have many organizations (tenants) that subscribe to the multi-tenant database. Each organization may have many users, and thus the total number of users may be quite large. In addition, processing of login requests can require authorization and privilege checking, which can use substantial amount of computational effort. These factors coupled with the aforementioned repeated logins can combine to provide a large load on a multi-tenant database from login requests from users.

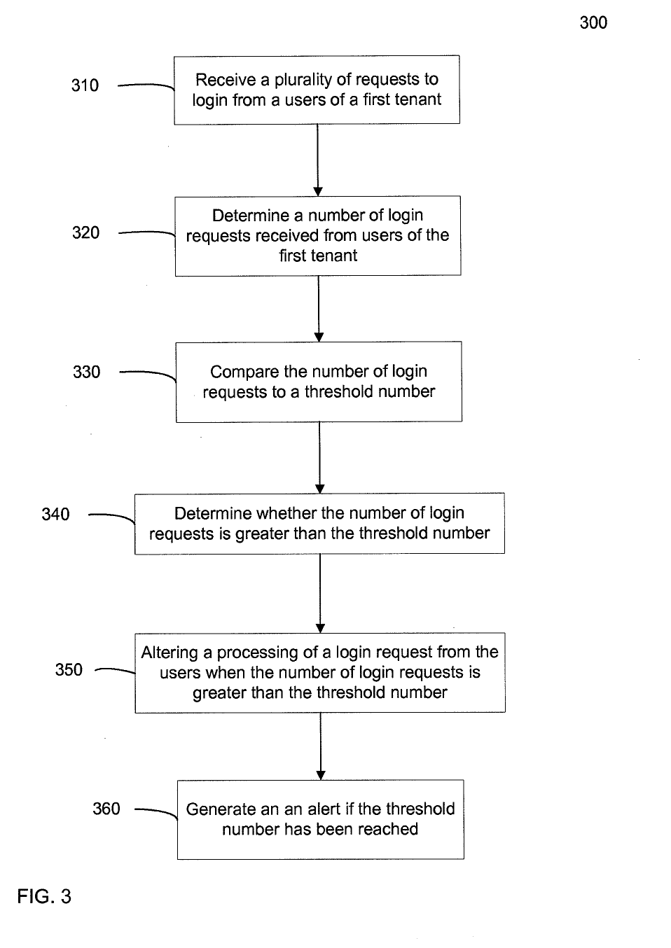

FIG. 3 is a flow chart illustrating a method 300 for reducing a load on a multi-tenant database system having a plurality of tenants according to embodiments of the present invention. In a multi-tenant database, certain resources are shared among the tenants. However, if one tenant (on purpose or by accident) performs many logins, that tenant could use an unfair or disproportionate share of the resources. Accordingly, embodiments can reduce a load caused by a tenant, user, or groups of users that send too many login requests.

In step 310, one or more servers of the multi-tenant database system receive a plurality of requests to login from one or more users of a first tenant. The user logins may be processed to provide the user with access to the database. Such processing can include authentication (e.g., identification of a valid username along with the correct password), a look up of a security profile to identify which data and pages can be seen, tracking of information about login and user, updating a timestamp, and providing homepages and dashboards. In one embodiment, concurrent login requests may be placed into a queue.

In step 320, the multi-tenant database system determines a number of login requests received from the one or more users of the first tenant. The one or more users may be all the users of the first tenant, or just a portion of the users. In one embodiment, the logins from the users are tracked based on a common profile within a tenant. For example, different groups of users (with a same profile or part of a profile) within one tenant may be tracked separately. The login requests for other tenants may also be tracked in a similar manner, as described herein.

In one embodiment, the number of requests are determined over a specific time period, e.g., during one day. In another embodiment, the number of requests are determined over a predetermined time interval (length of time). For example, a rolling time interval of one hour may be used, i.e. the number of requests in the last hour would be determined.

In step 330, the number of login requests is compared to a threshold number. In one embodiment, the threshold is tenant-dependent and may differ from tenant to tenant. In another embodiment, the threshold number varies based on the time of day, week etc. In yet another embodiment, the threshold number may vary based on a current load on the entire database, or based on a current load on a particular part of the database, e.g., on serve. Thus, each server could have its own threshold. For example, if the load is high, the threshold number can be made lower. If the load is low, the threshold number can be made higher since more resources are available. Some embodiments can combine the different dependencies of the threshold number to determine the threshold number to be used for a respective comparison.

The comparison may be performed at various components of the multi-tenant database. For example, the comparison may be performed at an upstream component (e.g. a server that interacts with user systems) or at a downstream component (e.g. a processor that handles queries or other system administration).

The comparison may be performed at various times as well. In one embodiment, the comparison can be made after each new login request is received. In another embodiment, the comparison is made only after predetermined time intervals, where multiple login requests may be received between comparisons.

In step 340, it is determined whether the number of login requests is greater than the threshold number. In one embodiment, the threshold is 3600 login requests per hour, i.e. an average of 1 every second. The number of login requests being greater than the threshold number can be a sign that the first tenant is improperly using the database system. For example, poorly written code may be improperly logging in repeatedly.

In step 350, when the number of login requests is greater than the threshold number, the multi-tenant database system alters how a login request from the one or more users of the first tenant is processed. The processing of login request may be altered in various ways. In one embodiment, login requests from the first tenant are denied after the threshold number has been reached. The denial may last for a predetermined length of time. In another embodiment, the login requests from the first tenant may be delayed. In one aspect, the delay may be a fixed delay. In another aspect, a login request may be delayed by placing the request into a particular queue that is serviced at a low priority relative to other login requests and/or other actions. In this manner, the load from login requests of the first tenant can be reduced when the first tenant is using more than an allocated or otherwise appropriate amount of resources.

In step 360, an alert can be generated if the threshold number has been reached. In one embodiment, the alert can be generated and sent to the customer, e.g., via an e-mail, text message, or other electronic message. In this manner, the first tenant can take steps to rectify the number of login requests being sent. For example, the first tenant can identify the poorly written code or identify a user(s) that are logging in an inordinate amount of times. In another embodiment, the alert can be sent to an internal administrator of the database system and/or stored into a log file. Someone can follow up with the first tenant or user of the first tenant at a later time. The internal administrator or a management program can also take other steps, such as increasing the threshold number.

Some embodiments may track the number of logins per username (e.g. in tables) when finer granularity beyond tenant usage is desired. For example, the users of a tenant may be split into groups with the logins from each group being tracked separately. One way to perform such tracking is to track a number of logins for each user. Additionally, the login information per user may be useful to identify specific individuals that are sending too many login requests are therefore a source of the problem. In one embodiment, invalid usernames are kept out of the limit tables in order to prevent denial of service (DoS) attacks that could cause the amount of memory used to track the usernames to increase to an extent that the database system (e.g. a server) to not function properly.

Regarding a choice for a set time period or a rolling time interval, considerations may be made for the computational effort expended in tracking the number of login requests. For a large number of users and/or tenants, limiting logins per day may be expensive, particularly when a maximum number of unique logins per day can be around 74,000. In embodiment where the tracking of logins includes storing a hash of usernames in memory on an application server (e.g. server(s) 100) and/or API server (e.g. server 32), tracking double the number of unique logins (e.g. to have a cushion for additional capacity) would mean keeping a hash of 150,000 usernames in memory. This amount of memory can be significant. In contrast, limiting by hour can be close to a quarter of the number per day, e.g. 19,000 unique usernames with a capacity for 38,000 giving about 2.3 MB of hash keys assuming 30 character/60 byte usernames.

The threshold number(s) can be configurable at several layers. In one embodiment, a tenant-level threshold number is imposed for the total number of login requests received from the users of a tenant. In another embodiment, each user may have an individual limit (threshold) imposed. In one aspect, the individual limit may be the same for each user of a particular tenant, but may vary from tenant to tenant. In another aspect, the individual limit may be based on a profile associated with the user, thus different users of a tenant may have different limits. In yet another embodiment, a group-level limit may be based on a total number of login requests received from users of a particular group, where the group does not include all of the users of the tenant. Each of these embodiments may be combined to provide various threshold limits for a particular user, group, and/or tenant. A login history record can also be created when a user, group, and/or tenant reaches the limit.

Accordingly, embodiments can reduce a load from repeated logins from users. For example, embodiments can detect when a tenant organization writes code that polls the database often, with each polling requiring a new login, instead of logging in once and re-using the existing connection.

Rate Limiting in a Multi-Tenant Database with a Plurality of Servers

In some embodiments, all of the login requests may be handled by a single server. In other embodiments, a few or many servers may handle the login requests. Embodiments using a plurality of servers is now described.

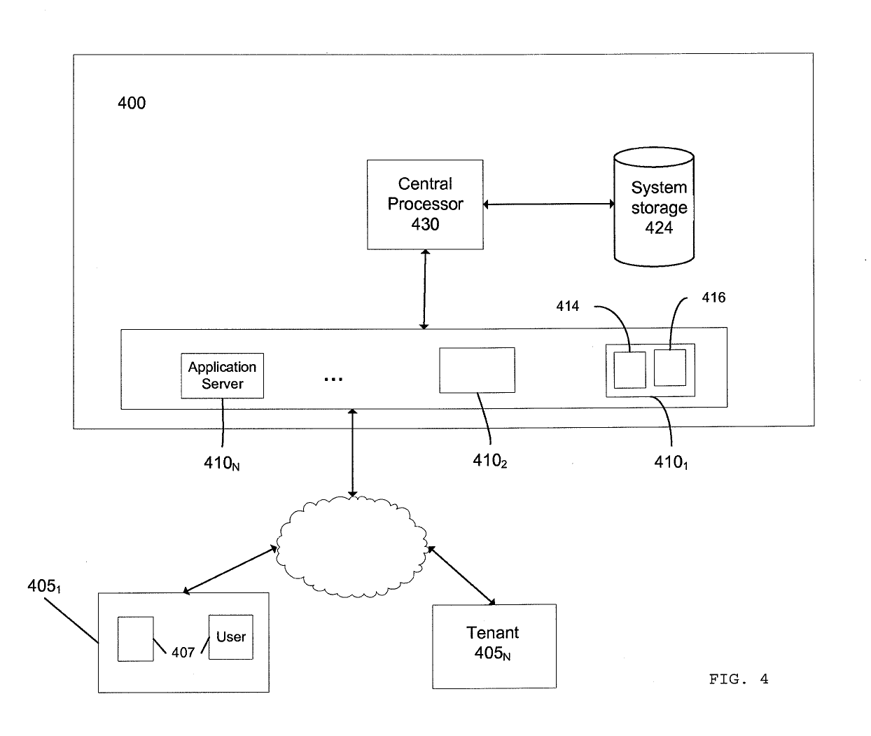

FIG. 4 shows a block diagram of a multi-tenant database 400 having a plurality of servers and configured to limit a rate of user logins according to embodiments of the present invention. Application servers 410 (which can correspond to application servers 100) receive login requests from users 407 of various tenants 405. The application servers 410 can be configured to track login requests. A central processor 430 and system storage 424 may be used to help in the tacking.

In one embodiment, each application server 410 is configured to count the number of login requests (“first login requests”) received from each tenant 405 (and/or each user 407) during a first time interval. For example, each application server 410 may be configured to count the number of login requests received from a first tenant 405₁ during a most recent first time interval (e.g. every 15 seconds). The count may be stored in a first memory location 414, as shown for application server 410₁. These counts may be flushed after each time interval (e.g. every 15 seconds) and summed to determine a total number of login requests (“total logins”) received during a second time interval (e.g. the last 60 minutes).

Accordingly, each application server 410 may track the total login requests for each tenant, which may have one or more users issuing request to the application server via the users' user systems. Each application server 410 may include a second memory location 416 that is configured to store the total number of requests for each tenant 405 (and/or each user 407 or group of users) for the second time interval. The information in memories 414 and 416 might be organized by tenant with sections for each user of a respective tenant. In addition to tracking a number of login requests, an application server may track a variety of other request (e.g. queries) and metadata that is associated with the requests, e.g., as described in U.S. patent application Ser. No. 11/616,657.

Each application server 410 can transfer the number of login requests during the first time interval to the central processor 430 (which may be a set of processors). The central processor 430 may be configured to accumulate the first login requests received from each application server for each tenant 405 on a per tenant basis. In one aspect, the central processor 430 can be in communication with every login path so that all logins are counted. In one embodiment, the central processor 430 may be one of the application servers 410.

In some embodiments, a history of the first login requests, e.g., for each tenant, user, or group, may be stored in system storage 424. In one embodiment, the history includes the number of login requests received for each first time interval (e.g. 15 seconds) received during a second time interval (e.g. the last 60 minutes). Thus, a sum could include the number of first logins received during each of the first time intervals. The history may be stored in tables in a similar format or in the same tables as the tenant data.

In others embodiments, the history includes the total number of login requests received for each second time interval that has ended during a length of time equal to a second time interval. For example, when the first time interval equals 15 seconds and the second time interval equals 60 minutes, there have been 240 separate second time intervals that have ended. The total number of requests for each of these second time intervals effectively stores the same information as the number of login requests received for each first time interval. In this embodiment, a sum could include the number of first logins received during the new first time interval, plus the total number of requests received during the last second time interval, minus the number of first login requests that were received at the end of the last second time interval (e.g. the last 15 seconds of the previous 60 minute period).

The central processor 430 may be configured to send, to each application server 410, the accumulated number of total requests for all or a subset of the application servers. For example, if application server 410₁ has received 15 total requests, but application servers 410₂-410_{N} have cumulatively received 45 total requests, then application server 410₁ may be informed by central processor 430 of the 55 total requests received by all of the application servers 410₁-410_{N}.

Alternatively, the central processor 430 can send, to each application server 410, the number of total requests received by each of the other application servers. For example, if application server 410₁ has received 15 total requests, but application servers 410₂-410_{N} have cumulatively received 45 total requests, then application server 410₁ may be informed by the central processor 430 of the 45 total requests received by the other application servers 410₂-410_{N}.

As mentioned above, each application sever 410 may include a second memory location 416 that is configured to store the number of total requests during a second time interval. First memory location 414 and second memory location 416 may be part of a same memory device or be stored in two different memory devices. In one aspect, second memory location 416 may store the number of requests for each of the application servers 410, thus the number of total requests is effectively stored, although a summing operation might be required to obtain the number of total requests.

Regarding the threshold numbers, each tenant 405 may be associated with a threshold number of total requests. The threshold number of total requests associated with a tenant may be associated with the tenant's status. For example, a tenant that is a paying subscriber of system 400 may be assigned a higher threshold numbers of total requests than a non-paying tenant of system 400. In one aspect, a developer of software for the database system 400 may be a non-paying tenant.

According to one embodiment, for each tenant, each application server may be configured to compare the number of total requests for the tenant with the threshold number of total requests for the tenant. The number of total request used for the comparison might include: (i) the number of requests stored in first memory location 414 plus the number of total requests stored in second memory location 416 (referred to as option one) or (ii) the number of total requests stored in second memory location 416 (referred to as option two).

An application server might make the comparison based on option one if it is desired to immediately identify when a number of login requests has exceeded a threshold. However, in this case, the number of requests could be those received over a time interval could be longer than the second time interval. An application server might make the comparison based on option two if the identification of when a number of login requests has exceeded a threshold can wait until the end of the next first time interval (e.g. after 15 seconds).

As a third option, an application server might make the comparison based on the number of requests stored in first memory location 414 and old values for the number of total requests if the application server is unable to collect from central processor 430 the number of total request received by the other application servers 430. For example, if one or more networks that couple the other application servers 410 to the central processor 430 fail, the central processor 430 may be unable to collect the number of total requests received by the other application servers.

Alternatively, central processor 430 may be configured to determine whether any of the accumulated values of logins is greater than a threshold number. The central processor 430 can then send an instruction to each application server 410 as to which tenants, users, or groups of users have exceeded a respective threshold number.

If it is determined that the number of total requests for a given tenant exceeds the threshold number of total requests for the given tenant, then an application server may be configured to take one or more actions. For example, if the number of total requests for a tenant, user, or groups of users exceeds a threshold number, then the application server may be configured to send a message to each of the given tenant's user systems that are in communication with (e.g., issuing login requests) the application server. The message might be a warning that the tenant, user, or group has exceeded a total login request limit.

Alternatively, if the number of total request exceeds the threshold number of total requests, then an application server may be configured to refuse further requests from the user systems of the given tenant, and may send a message to indicate the reason for refusing the tenant's further requests. These various actions taken by an application server might further be based on a tenant's status. For example, a paying tenant may receive a number of messages before the application servers refuse the tenant's request, whereas the application servers for a non-paying tenant may or may not receive a message before the application servers refuse the tenant's request.

Each application server 410 may also be configured to track the number of current login requests that have been issued by a set of user systems currently accessing the application server. A current login request is a request that is being processed at a given instant of time. The application server may track the number of current login requests for each tenant, which may have one or more users that are issuing requests to the application server via the users' user systems. The description of tracking a number of login requests during a time interval may also be applied to tracking current login requests.

The number of current login requests may be high, e.g., when an entity is using code that logs into the database every time a service was requested, but does not logout. A log in could get timed out after a set time period, but there still could be many active at one time. In one embodiment, a threshold number for current login requests by an entity (tenant, user, or group of users) may be based on the number of licenses (i.e. unique users that can be logged in at one time).

Multiple different thresholds could be tested at the same time. For example, the concurrent threshold could be tested at the same time as a rolling hour threshold. As another example, an entity could be checked against different thresholds, which may change (e.g. depending on time), thereby requiring a check against multiple thresholds.

Monitoring a tenant's total login requests and current login requests, and limiting the number of total requests and/or current request and/or providing a warning to the tenant of high usage provides that system 400 does not become overloaded with login requests, such as in an unpredictable manner.

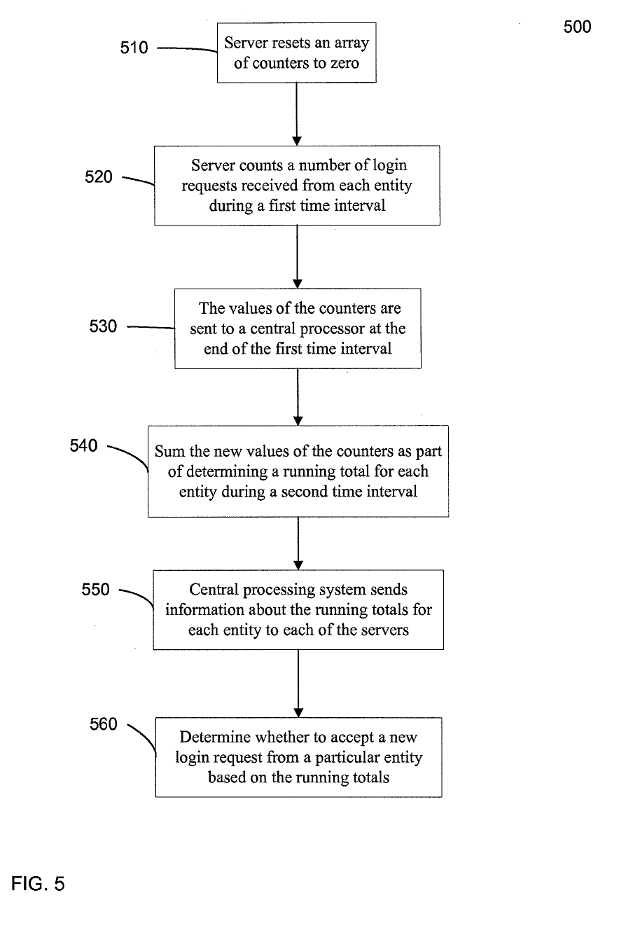

FIG. 5 is a flow chart illustrating a method 500 for reducing a user login load on a multi-tenant database having a plurality of servers according to embodiments of the present invention. In method 500, a number of logins from a tenant, user, or group of users (or any combination therefore) may be determined. The following description is generic as to which entity the login requests are being tracked, and may be repeated for each entity. In one aspect, method 500 may be used by database system 16 or 400. In one embodiment, certain entities can have their login behavior set to not be tracked and limited.

In step 510, a server resets an array of counters to zero. Each counter counts a number of login requests for a specific entity (e.g. user, tenant, or group). In one embodiment, the resetting occurs after the end of a first time interval, e.g., 15 seconds. This resetting may occur right after the contents of the counters are sent to a central processing system, e.g., as described above for system 400. The counters may be of any type of suitable memory devices.

In step 520, during a first time interval, a server uses the counters to track a number of login requests received from each entity. If the entity (e.g. a user) is not being tracked yet, data for the user and potentially for the tenant to which the user belongs can be loaded into the server, e.g. into a persistent memory such as a hard drive or a dynamic memory such as RAM. In one embodiment, the data includes the username of the user so that each user can be accurately tracked. In one aspect, an entity may not be tracked if a login request from the entity has not been received recently, e.g., within the second time interval mentioned below. For example, if a login request has not been received recently, tracking of the entity can be stopped and memory for such tracking can be released.

In step 530, at the end of the first time interval, the values of the counters are sent to a central processing system. In one embodiment, the central processing system includes one of the servers. In another embodiment, the central processing system includes one or more processors that are separate form the servers. In one aspect, the central processing system stores (e.g., in the database) a history of the values of the counters for a plurality of previous first time intervals. In one embodiment, the data is sent (flushed) to the central processing system less than every minute (e.g. 15-30 seconds). This may be handled by a background thread that performs the flushing. The counters may be periodically reset at the end of each first time interval and can begin counting for a new time interval.

In step 540, the new values of the counters are summed as part of determining a running total for a second time interval, which is longer than the first time interval. The summing may be performed by the central processing system or by the servers if the values of the counters from the other servers have been distributed.

In one embodiment, the sum of new values of the counters can be added to sums for previous first time intervals (e.g. sums for previous 15-second intervals). In another embodiment, the sum of new values of the counters can be added to the last running total for the last second time interval. A sum from the counter values from a first time interval that was in the last second time interval would then need to be subtracted. For example, the database can keep track of the number of login requests that were received an hour ago, and then those would be dropped from the total. Thus, the new total could be less that the last total calculated.

In step 550, the central processing system sends information about the running totals for each entity to each of the servers. In one embodiment, the information includes whether the running total has exceeded a threshold number for any of the entities being tracked. In another embodiment, the information includes the running totals, which may be determined by the central processing system. In another embodiment, the information includes the number of first login request received during the most recent first time interval,

At this point, all of the servers are brought up to date on the total number of login requests that have been received during the most recent second time interval. Note that counters may already be counting new login requests, but in one embodiment these login requests may be considered as being for the next second time interval. In another embodiment, these new values of the counters can be included in a determination of whether a threshold limit has been reached.

In step 560, it is determined whether to accept a new login request from a particular entity based on the running totals. In embodiments where the server receives information that a threshold number has been exceeded, the server can be configured to no longer accept logins from the particular entity. The tracking of the login request for an entity that has exceeded a threshold can be stopped. In one aspect, the server can be configured to resume accepting logins if the rolling total drops below the threshold number. In another aspect, a resumption of accepting logins can require action by an administrator.

In embodiments where the servers receive the running totals, the servers can determine whether a threshold has been exceeded, and thus determine whether to accept a new login request from a particular entity. As mentioned above, the determination of whether a threshold has been exceeded can use the current values of the counters as well as the running totals.

Embodiments can also parse through login logs to determine appropriate threshold to use or to update the thresholds to ensure that the thresholds remain consistent with usage. In various embodiments, username, client IP, login type, login result, runtime, CPU time, total count, unique count, and average runtime of a login may be used to determine an appropriate threshold.

### Reducing Load of Denial of Service Attack

Besides logins from valid users, logins from invalid users can also be a problem. Even if a login is unsuccessful, the amount of computational effort can be significant when there are many unsuccessful logins. For example, authorization of a user and checking the privileges as to the data that a user can access is a non-trivial amount of database work. Thus, an anonymous person on the internet can generate a significant load on the database. A malicious person could use this vulnerability to swamp the service with login requests, thereby consuming database resources and preventing customers from using the service.

However, determining if a random invalid username is just a simple mistake or the harbinger of an attack is difficult. In some embodiments, a client's IP address, number of requests from a particular address in a given window of time, or patterns in the usernames can be used to determine whether an invalid username is part of an attack. If a particular address is identified as being part of an attack, logins from that address can be blocked. In any event, whether intentional or a mistake, the login request should be screened out and dropped using the minimum amount of system resources.

Another embodiment for limiting login is to introduce an increasing delay in processing login requests for a given user. Doing this for the random user denial of service (DoS) scenario would require keying off something other than username, such as client IP address. However, valid users people behind gateway or proxy server might also be screened out. Also, the address of the attacker may need to be persisted into the database and replicated into all the servers.

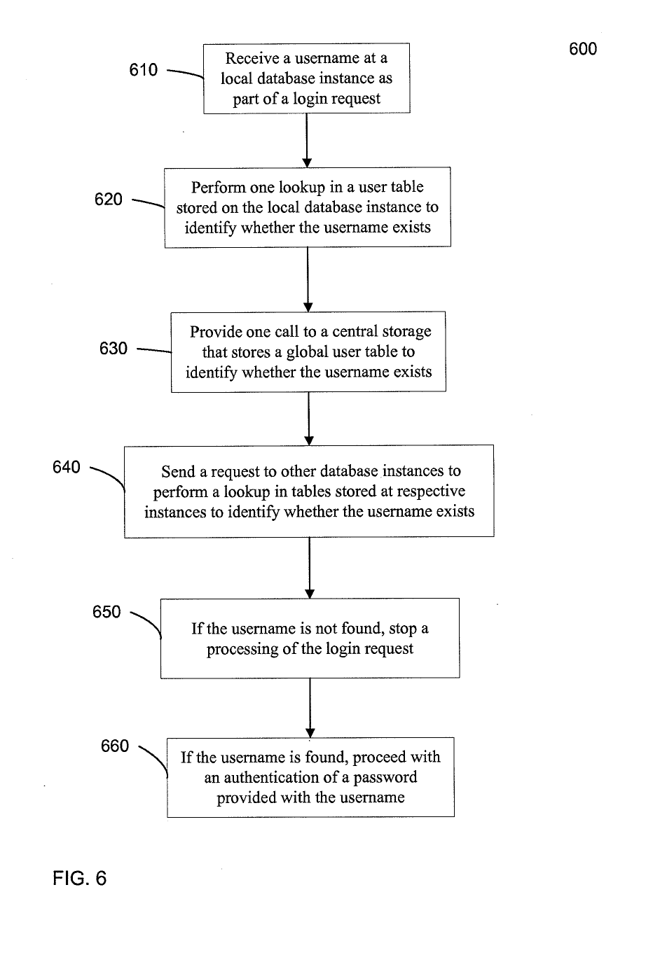

FIG. 6 is a flowchart illustrating a method 600 for reducing a load on a database from invalid user logins according to embodiments of the present invention. Method 600 can detect whether a username exists prior to performing any authentication, and thus can exit quickly and reduce the load on database resources. Method 600 can also ensure that a check for whether a username exists is accurate.

In step 610, a username is received at a local database instance as part of a login request. In one embodiment, the local database instance is running on a first server of the database.

In step 620, one lookup in a user table stored on the local database instance is performed to identify whether the username exists. In one embodiment, the user table on the local database instance is stored in a persistent storage as part of the database.

In step 630, one call is provided to a central storage that stores a global user table to identify whether the username exists. The call to the database storage can be sent to a processor, which performs accesses to the central storage. In one embodiment, the global user table is updated with username information entered through a database instance and replicated to the global user table.

In step 640, the local database instance sends a request to a plurality of other database instances to perform a lookup in tables stored at respective database instance to identify whether the username exists. In one embodiment, the requests to the database instances determine which instance the user belongs to and should handle an authentication call if the username does exist. In another embodiment, each of the steps 620-640 can be performed in parallel. In one aspect, the lookup calls to the other instances are performed in the case of a new user whose identity hasn't yet been replicated.

In step 650, if the username is not found, a processing of the login request is stopped. Accordingly, in one embodiment, a load on the database may be reduced by not performing any work beyond that of identifying that the username does not exist. In another embodiment, only one lookup is performed of each that table could store a list of valid usernames.

In step 660, if the username is found, proceeding with an authentication of a password provided with the username. For example, the password that was entered with the username can be checked with the password on file.

Although method 600 can reduce a load on the database, a check is still performed of every database instance for an invalid username and the central user table, and such checks may be performed to persistent data storage devices, which can be relatively slow. One way to avoid that work would be to cache the valid usernames in a local memory (e.g. cache of a processor of a server or RAM on a system board) and check the attempted username against the cache before proceeding with any further lookup calls. However, storing all of the usernames in memory can be quite expensive.

To overcome this memory limitation, embodiments use a Bloom filter stored in memory on each server of the database to screen out a large percentage (e.g. 99% or better) of the invalid usernames. The Bloom filter can require much less memory space than storing all of the usernames. The Bloom filter allows detection of whether the username does not exist, but in one embodiment does not convey additional information. This focus on detecting on whether a username does not exist allows the amount of required memory to be relatively small. For example, one embodiment only requires one byte of memory per username, which may correspond to about 2 MB in each app server. The use of the Bloom filter may be tied into account creation and/or replication though so that newly created users are not screened out by the filter.

Accordingly, with the use of a Bloom filter, the amount of computational effort may be minimal since the information of whether a username exists is stored in working memory (e.g. cache or RAM) and may be identified with just one call. A call to the database is not needed to determine the non-existence of the username. If a username probably does exist as determined by the Bloom filter (false positives may occur), the username can be verified to exist. But, since the number of false positives is relatively small, this verification would normally be done only for valid usernames.

One drawback of handling an invalid username very fast is that a malicious person could time the login requests as a way to mine the database system for valid usernames. In some embodiments, the database system delays the response to a user system on whether a login request has failed relative the actual amount of time that it takes to make the determination.

In one embodiment, the response to an invalid login takes as much wall clock time to complete as it does for a correct username that is not authenticated (e.g. has the wrong password). Thus, invalid usernames can be made to fail early to save system resources, but still be made to ‘appear’ to take the same time. For example, to mimic that an invalid username takes the same time in failing as a valid username, the login code waits for X amount of time, where X equals the time taken by the last incorrect password login.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies

It should be understood that the present invention as described above can be implemented in the form of control logic using hardware and/or using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive or an entire computer system), and may be present on or within different computer program products within a system or network. A computer system may include a monitor, printer, or other suitable display for providing any of the results mentioned herein to a user.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

What is claimed is:

1. A method for reducing a load on a multi-tenant database system having a plurality of tenants, the method comprising:
receiving, at one or more servers of the multi-tenant database system, a plurality of requests to login from one or more users of a first tenant;
determining, with the multi-tenant database system, a number of login requests received from the one or more users of the first tenant;
comparing the number of login requests to a threshold number; and
determining whether the number of login requests is greater than the threshold number.

2. The method of claim 1, further comprising:
when the number of login requests is greater than the threshold number, altering how a login request from the one or more users of the first tenant is processed by the multi-tenant database system.

3. The method of claim 1, wherein the number of login requests is determined by counting login requests received from the one or more users of the first tenant during a predetermined length of time.

4. The method of claim 3, wherein the predetermined length of time is one hour.

5. The method of claim 3, wherein determining a number of login requests received during the predetermined length of time is performed periodically, and comparing the number of login requests to a threshold number is performed after each predetermined length of time.

6. The method of claim 1, wherein altering how a login request from the one or more users of the first tenant is processed includes:
stopping a processing of login requests from the one or more users of the first tenant.

7. The method of claim 1, wherein altering how a login request from the one or more users of the first tenant is processed includes adding a delay for login requests from the one or more users of the first tenant.

8. The method of claim 1, wherein the plurality of login requests are received at a plurality of servers of the multi-tenant database system, and wherein determining the number of login requests received from the one or more users of the first tenant includes:
determining, with each server, a first number of login requests received by the respective server during a first time interval;
sending, from each server to a central processing system, the first number of login requests received by the respective server; and
calculating a total number of login requests received by all of the servers during a second time interval by summing:
the first numbers of login requests received by each respective server during the first time interval; and
a number of login requests previously received during the second time interval, wherein the second time interval is longer than the first time interval and includes the first time interval,
wherein the total number of login requests is used as the number of login requests received from the one or more users of the first tenant.

9. The method of claim 8, wherein the central processing system stores a history of the first numbers of login requests received by the servers during different first time intervals occurring over a rolling time period that has a length equal to the second time interval.

10. The method of claim 8, further comprising:
sending, from the central processing system, the total number of login requests received by all of the servers during the second time interval to each of the servers,
wherein comparing the number of login requests to a threshold number is performed by each server.

11. The method of claim 8, further comprising:
sending, from the central server to each server, an instruction at to whether each tenant has exceed the threshold number.

12. The method of claim 1, further comprising:
determining whether the number of login requests of each of a plurality of the tenants is greater than a respective threshold number, wherein the value of the respective threshold number is dependent on the tenant.

13. The method of claim 1, further comprising:
determining a number of login requests received from each user of the first tenant and a number of login requests received from all of the users of the first tenant;
determining whether the number of login requests received from a first user of the first tenant is greater than a first threshold number; and
determining whether the number of login requests received from all of the users of the first tenant is greater than a second threshold number, wherein the first threshold number is greater than the second threshold number.

14. The method of claim 1, wherein the threshold number is time-dependent.

15. The method of claim 1, wherein the plurality of login requests are received at a plurality of servers of the multi-tenant database system, the method further comprising:
receiving a username at a local database instance as part of a login request;
performing one lookup in a user table stored on the local database instance to identify whether the username exists;
providing one call to a central storage that stores a global user table to identify whether the username exists;
sending, from the local database instance, a request to a plurality of other database instances to perform a lookup in user tables stored at respective database instances to identify whether the username exists;
if the username is not found, stopping a processing of the login request; and
if the username is found, proceeding with an authentication of a password provided with the username.

16. The method of claim 15, further comprising:
using a bloom filter stored in a memory of a first server to check whether a username is in a list of valid usernames; and
if the username is not is in a list of valid usernames, stopping a processing of the login request.

17. The method of claim 15, further comprising:
sending a failed login notice in response to the stopping of a processing of the login request if the username is not found;
adding a delay to the sending of the failed login notice such that the failed login notice using an invalid username is sent at a same elapsed time that a failed login notice using a valid username but with an incorrect password is sent relative to when a login request is received.

18. A machine-readable medium carrying one or more sequences of instructions for reducing a load on a multi-tenant database system having a plurality of tenants, which instructions, when executed by one or more processors, cause the one or more processors to carry out the steps of:
receiving, at one or more servers of the multi-tenant database system, a plurality of requests to login from one or more users of a first tenant;
determining, with the multi-tenant database system, a number of login requests received from the one or more users of the first tenant;
comparing the number of login requests to a threshold number; and
determining whether the number of login requests is greater than the threshold number.

19. A multi-tenant database system comprising:
one or more servers configured to receive a plurality of requests to login from one or more users of a first tenant;
one or more processors configured to:
determine a number of login requests received from the one or more users of the first tenant;
compare the number of login requests to a threshold number; and
determine whether the number of login requests is greater than the threshold number.
